(19) United States
(12) Patent Application Publication
(10) Pub. No.: US 2024/0427941 A1
(43) Pub. Date: Dec. 26, 2024

(54) MEMORY SYSTEM GENERATING ERASE CERTIFICATE

(71) Applicant: Kioxia Corporation, Tokyo (JP)

(72) Inventors: Naoki ESAKA, Kawasaki (JP); Yoshiyuki KUDOH, Kawasaki (JP)

(73) Assignee: Kioxia Corporation, Tokyo (JP)

(21) Appl. No.: 18/822,835

(22) Filed: Sep. 3, 2024

Related U.S. Application Data
(63) Continuation of application No. PCT/JP2022/033420, filed on Sep. 6, 2022.

(51) Int. Cl. G06F 21/64; G06F 21/79

(52) U.S. Cl. CPC G06F 21/64; G06F 21/79

(57) ABSTRACT

According to one embodiment, a memory system includes a nonvolatile memory and a controller. The nonvolatile memory includes storage areas each configured to store user data. The controller acquires first information related to the number of program/erase cycles for at least one of the storage areas. In response to acquisition of the first information, the controller executes a data erase operation on each of the storage areas. In response to completion of the data erase operation, the controller acquires second information related to the number of program/erase cycles for the at least one of the storage areas. The controller generates an erase certificate that includes the first information and the second information.

### CROSS-REFERENCE TO RELATED APPLICATIONS

This application is a Continuation Application of PCT Application No. PCT/JP2022/033420, filed Sep. 6, 2022, the entire contents of which are incorporated herein by reference.

### FIELD

Embodiments described herein relate generally to a technique for controlling a nonvolatile memory.

### BACKGROUND

In recent years, memory systems including a nonvolatile memory have been widely used. As one of such memory systems, a solid state drive (SSD) that includes a NAND flash memory is known. The SSD is used as a main storage of various computing devices.

A function capable of ensuring that data has been definitely erased (sanitized) from the nonvolatile memory of the memory system is important. In use of the memory system, for example, it may be required to certify that data has been erased from the nonvolatile memory. The certification that the data has been erased from the nonvolatile memory is provided as, for example, an electronic certificate that includes log data of a data erase operation on the nonvolatile memory and a digital signature attached to the log data.

### BRIEF DESCRIPTION OF THE DRAWINGS

FIG. 1 is a block diagram illustrating an example of a configuration of an information processing system that includes a host and a memory system according to an embodiment.

FIG. 2 is a diagram illustrating an example of a data erase and certificate generation operation performed by the host and the memory system according to the embodiment.

FIG. 3 is a diagram illustrating an example of a certificate issuance operation performed by the host and the memory system according to the embodiment.

FIG. 4 is a diagram illustrating an example of a certificate verification operation in the host that has acquired a data erase electronic certificate of the memory system according to the embodiment.

FIG. 5 is a flowchart illustrating an example of the procedure of a data erase and certificate generation process executed in the memory system according to the embodiment.

FIG. 6 is a flowchart illustrating an example

of the procedure of a certificate issuance process executed in the memory system according to the embodiment.

FIG. 7 is a flowchart illustrating an example of the procedure of a certificate verification process executed in the host that has acquired the data erase electronic certificate of the memory system according to the embodiment.

### DETAILED DESCRIPTION

In general, according to one embodiment, a memory system includes a nonvolatile memory and a controller. The nonvolatile memory includes a plurality of first storage areas each configured to store user data. The controller acquires first information related to the number of program/erase cycles for at least one of the plurality of first storage areas. In response to acquisition of the first information, the controller executes a data erase operation on each of the plurality of first storage areas. In response to completion of the data erase operation, the controller acquires second information related to the number of program/erase cycles for the at least one of the plurality of first storage areas. The controller generates an erase certificate that includes the first information and the second information.

Various embodiments will be described hereinafter with reference to the accompanying drawings.

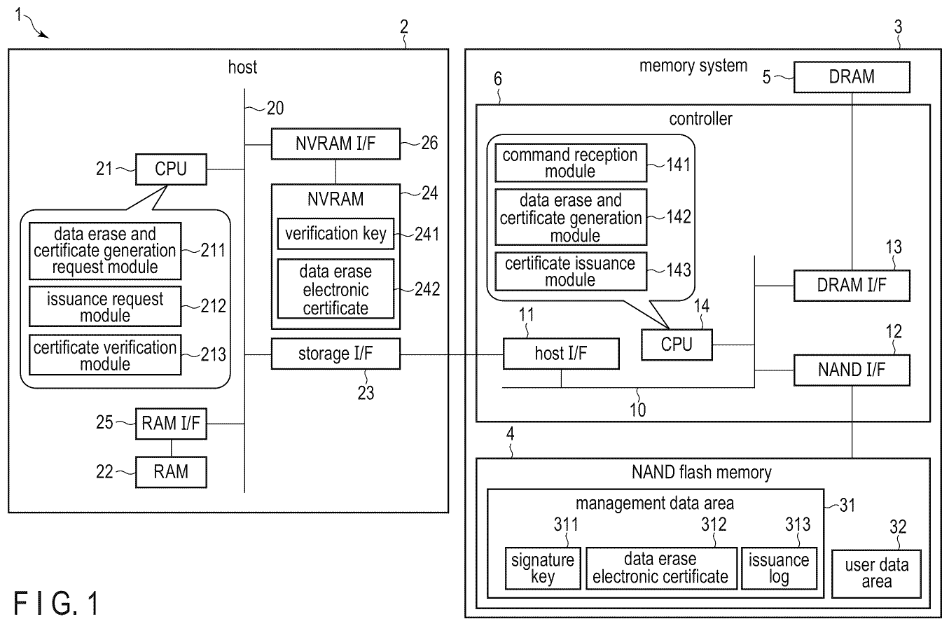

First, a configuration of an information processing system 1 that includes a memory system according to an embodiment will be described with reference to FIG. 1. The information processing system 1 includes a host device 2 and a memory system 3.

The host device 2 may be a storage server that stores a large amount of various data to the memory system 3 or may be a server or a personal computer. Hereinafter, the host device 2 is also referred to as a host 2.

The memory system 3 is a semiconductor storage device configured to write data into a nonvolatile memory such as a NAND flash memory and read data from the nonvolatile memory. The memory system 3 is also referred to as a storage device. The memory system 3 is implemented as, for example, a solid state drive (SSD) or a hard disk drive (HDD).

The memory system 3 may be used as a storage of the host 2. The memory system 3 may be provided inside the host 2 or may be connected to the host 2 via a cable or a network.

An interface for the communication between the host 2 and the memory system 3 conforms to standards such as PCI Express™ (PCIe™), Ethernet™, Fibre channel, or NVM Express™ (NVMe™).

An example of a configuration of each of the host 2 and the memory system 3 will be described below.

### Example of Configuration of Host 2

The host 2 includes, for example, a central processing unit (CPU) 21, a random access memory (RAM) 22, a storage interface (storage I/F) 23, a nonvolatile random access memory (NVRAM) 24, a RAM interface (RAM I/F) 25, and an NVRAM interface (NVRAM I/F) 26. The CPU 21, the storage I/F 23, the RAM I/F 25, and the NVRAM I/F 26 are connected via, for example, a bus 20.

The CPU 21 is, for example, at least one processor. The CPU 21 controls operations of various components of the host 2.

The RAM 22 is a volatile memory. The RAM 22 is, for example, a dynamic random access memory (DRAM) or a static random access memory (SRAM). A storage area of the RAM 22 is allocated as, for example, storage areas of an operating system (OS), drivers, and various application programs.

The storage I/F 23 functions as a control circuit that controls communication between the host 2 and the memory system 3. The storage I/F 23 transmits various commands, for example, input/output (I/O) commands and various control commands to the memory system 3. The I/O commands include, for example, a write command and a read command. The control commands include, for example, a data erase and certificate generation command and a certificate issuance command.

The NVRAM 24 is a nonvolatile memory. As the NVRAM 24, for example, a magnetoresistive random access memory (MRAM), a phase change random access memory (PRAM), a resistive random access memory (ReRAM), or a ferroelectric random access memory (FeRAM) is used. A storage area of the NVRAM 24 is allocated as a storage area of various types of data used for processes by the host 2. The various types of data used for the processes by the host 2 include, for example, a verification key 241 and a data erase electronic certificate 242. The verification key 241 and the data erase electronic certificate 242 are acquired, for example, from a storage external to the host 2 or from a computer on a network. The acquired verification key 241 and data erase electronic certificate 242 may be stored in a nonvolatile memory of the host 2, such as the NVRAM 24.

The verification key 241 is a key for verifying data provided from an external device (e.g., the memory system 3) outside the host 2. To the verification key 241, a verification key certificate issued by a certification authority (CA) is attached. The verification key certificate certifies the integrity (validity) of the verification key 241. The CA that issues the verification key certificate is, for example, an intermediate CA. For the intermediate CA, for example, a certificate is issued by a root CA. Note that the data provided from the external device is, for example, the data erase electronic certificate 242. Since the verification key certificate is issued, a third party can verify the data erase electronic certificate 242 by using a certificate chain according to a public key infrastructure (PKI).

The data erase electronic certificate 242 is an electronic certificate indicating that a data erase operation has been performed in the external device. The data erase electronic certificate 242 includes certification data and a digital signature. The certification data is data certifying that the data erase operation has been performed. The digital signature is data for verifying the integrity of the certification data. The host 2 may directly receive the data erase electronic certificate 242 from the external device, or may indirectly receive the data erase electronic certificate 242 from the external device via one or more other devices.

The RAM I/F 25 functions as a RAM control circuit configured to control access to the RAM 22. The NVRAM I/F 26 functions as an NVRAM control

circuit configured to control access to the NVRAM 24.

The CPU 21 functions as, for example, a data erase and certificate generation request module 211, an issuance request module 212, and a certificate verification module 213 by executing a program.

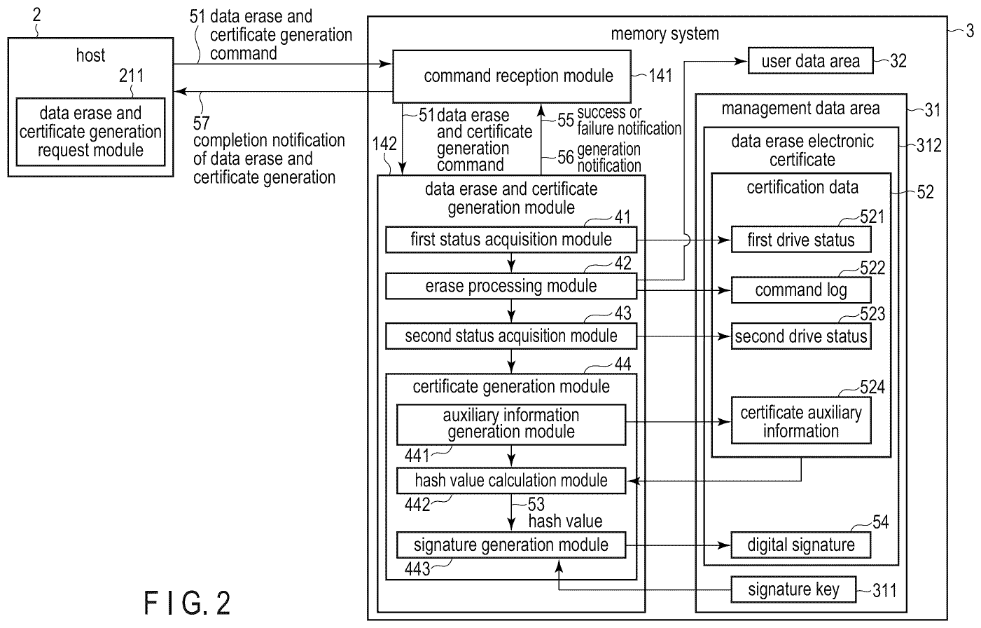

Specific operations of the data erase and certificate generation request module 211, the issuance request module 212, and the certificate verification module 213 will be described later with reference to FIGS. 2 to 4. The function of the data erase and certificate generation request module 211, the issuance request module 212, and the certificate verification module 213 may be realized by dedicated hardware in the host 2.

### Example of Configuration of Memory System 3

The memory system 3 includes, for example, a nonvolatile memory 4, a DRAM 5, and a controller 6.

The nonvolatile memory 4 is, for example, a NAND flash memory. Hereinafter, the nonvolatile memory 4 is referred to as a NAND flash memory 4.

The NAND flash memory 4 includes a plurality of blocks. Each of the plurality of blocks includes a plurality of pages. The blocks each function as a minimum unit of a data erase operation. The block may also be referred to as an erase block or a physical block. Each of the plurality of pages includes a plurality of memory cells connected to a single word line. The pages each function as a unit of a data write operation and a data read operation. Note that a word line may function as a unit of a data write operation and a data read operation.

The tolerable maximum number of program/erase cycles (maximum number of P/E cycles) for each of the blocks is limited. One P/E cycle of a block includes a data erase operation to erase data stored in all memory cells of the block and a data write operation (data program operation) to write data in each page of the block. Note that, as the number of P/E cycles, the number of P/E cycles for a storage area of a specific unit in the NAND flash memory 4 may be counted. The storage area of the specific unit includes, for example, a plurality of blocks on which a data erase operation is executable in parallel (i.e., collectively). The storage area of the specific unit may be referred to as a super block. In the memory system 3, for example, the number of P/E cycles for each of storage areas of the specific unit in the NAND flash memory 4 is managed.

To the NAND flash memory 4, for example,

management data and user data may be written. In other words, a storage area of the NAND flash memory 4 may be allocated as a storage area 31 for storing management data (hereinafter referred to as a management data area 31) and a storage area 32 for storing user data (hereinafter referred to as a user data area 32). The management data is data for managing operations of the memory system 3. The management data includes, for example, information used in a flash translation layer (FTL), a signature key 311, a data erase electronic certificate 312, and an issuance log 313.

The user data is data that is associated with a write command received from the host 2 and is to be written into the NAND flash memory 4.

The signature key 311 is a key for generating a digital signature that ensures the integrity of data provided from the memory system 3 to an external device (e.g., the host 2). In a case where the host 2 performs verification of the data provided by the memory system 3, the signature key 311 is used as a key paired with the verification key 241 stored in the host 2. The pair of the signature key 311 and the verification key 241 is a pair of unique keys generated for the memory system 3. The signature key 311 is stored in the NAND flash memory 4 before the memory system 3 is shipped, for example. The data erase electronic certificate 312 includes, for example, the data provided to the external device (e.g., the host 2) and the digital signature.

The data erase electronic certificate 312 is an electronic certificate indicating that a data erase operation has been performed on all storage areas in the NAND flash memory 4 that are capable of storing user data. The data erase electronic certificate 312 includes certification data and a digital signature. The certification data is data certifying that the data erase operation has been performed. The digital signature is data for verifying the integrity of the certification data. The data erase electronic certificate 312 may be generated when the data erase operation has been performed on all storage areas allocated as the user data area 32. The generated data erase electronic certificate 312 is stored in, for example, the NAND flash memory 4. Hereinafter, the data erase operation on all the storage areas allocated as the user data area 32 may be referred to as a data erase operation on the user data area 32.

The issuance log 313 is log data that indicates a history of issuance of the data erase electronic certificate 312 to an external device (e.g., the host 2) outside the memory system 3. The issuance log 313 includes, for example, a serial number assigned to the issued data erase electronic certificate 312, the date and time when the data erase electronic certificate 312 is issued, and information by which an external device that requested the issuance of the data erase electronic certificate 312 is identifiable.

The DRAM 5 is a volatile memory. A RAM such as the DRAM 5 includes, for example, a storage area of firmware (FW) and a cache area of a logical-physical address conversion table.

The FW is a program for controlling an operation of the controller 6. The FW is loaded from the NAND flash memory 4 to the DRAM 5, for example.

The logical-physical address conversion table is a table for managing mapping between each logical address and each physical address of the NAND flash memory 4. The logical address is an address used by the host 2 for addressing a storage area of the memory system 3. The logical address is, for example, a logical block address (LBA).

The controller 6 functions as a memory controller configured to control the NAND flash memory 4.

The controller 6 may function as the FTL configured to execute data management and block management of the NAND flash memory 4. The data management executed by the FTL includes (1) management of mapping data indicative of a relationship between each logical address and each physical address of the NAND flash memory 4, and (2) a process to hide a difference between data read/write operations in units of page and data erase operations in units of block. The block management includes management of defective blocks, wear leveling, and garbage collection.

The management of mapping between each logical address and each physical address is executed by using the logical-physical address conversion table. The controller 6 uses the logical-physical address conversion table to manage the mapping between each logical address and each physical address in a certain management size. A physical address corresponding to a logical address indicates a physical memory location in the NAND flash memory 4 to which data of the logical address is written. The controller 6 manages, by using the logical-physical address conversion table, a plurality of storage areas that are obtained by logically dividing the storage area of the NAND flash memory 4. The plurality of storage areas correspond to a plurality of logical addresses, respectively. That is, each of the plurality of storage areas is identified by one logical address. The logical-physical address conversion table may be loaded from the NAND flash memory 4 to the DRAM 5 when the memory system 3 is boot up.

The data write operation into one page is executable only once in a single P/E cycle. Thus, the controller 6 writes updated data corresponding to a logical address not to an original physical memory location in which previous data corresponding to the logical address is stored but to a different physical memory location. Then, the controller 6 updates the logical-to-physical address conversion table to associate the logical address with this different physical memory location rather than the original physical memory location and to invalidate the previous data (i.e., data stored in the original physical memory location). Data to which the logical-to-physical address conversion table refers (that is, data associated with a logical address) is referred to as valid data. Furthermore, data not associated with any logical address is referred to as invalid data. The valid data is data to be possibly read by the host 2 later. The invalid data is data not to be read by the host 2 anymore.

The controller 6 includes, for example, a host interface (host I/F) 11, a NAND interface (NAND I/F) 12, a DRAM interface (DRAM I/F) 13, and a CPU 14. The host I/F 11, the NAND I/F 12, the DRAM I/F 13, and the CPU 14 are connected via, for example, a bus 10.

The host I/F 11 functions as a circuit that receives various commands, for example, I/O commands and various control commands, and data from the host 2. In addition, the host I/F 11 functions as a circuit that transmits a response to a command and data to the host 2.

The NAND I/F 12 electrically connects the controller 6 and the NAND flash memory 4. The NAND I/F 12 conforms to an interface standard such as a toggle double data rate (DDR) and an open NAND flash interface (ONFI).

The NAND I/F 12 functions as a NAND control circuit configured to control the NAND flash memory 4. The NAND I/F 12 may be connected to a plurality of memory chips in the NAND flash memory 4 via a plurality of channels (Ch), respectively. By operating the memory chips in parallel, it is possible to broaden an access bandwidth between the controller 6 and the NAND flash memory 4.

The DRAM I/F 13 functions as a DRAM control circuit configured to control access to the DRAM 5.

The CPU 14 is a processor configured to control the host I/F 11, the NAND I/F 12, and the DRAM I/F 13. The CPU 14 performs various processes by executing the FW loaded from the NAND flash memory 4 to the DRAM 5. The FW is a control program that includes instructions for causing the CPU 14 to execute the various processes. The CPU 14 may execute command processes to execute various commands from the host 2. The operation of the CPU 14 is controlled by the FW executed by the CPU 14.

The function of each unit of the controller 6 may be realized by dedicated hardware in the controller 6 or may be realized by the CPU 14 executing the FW.

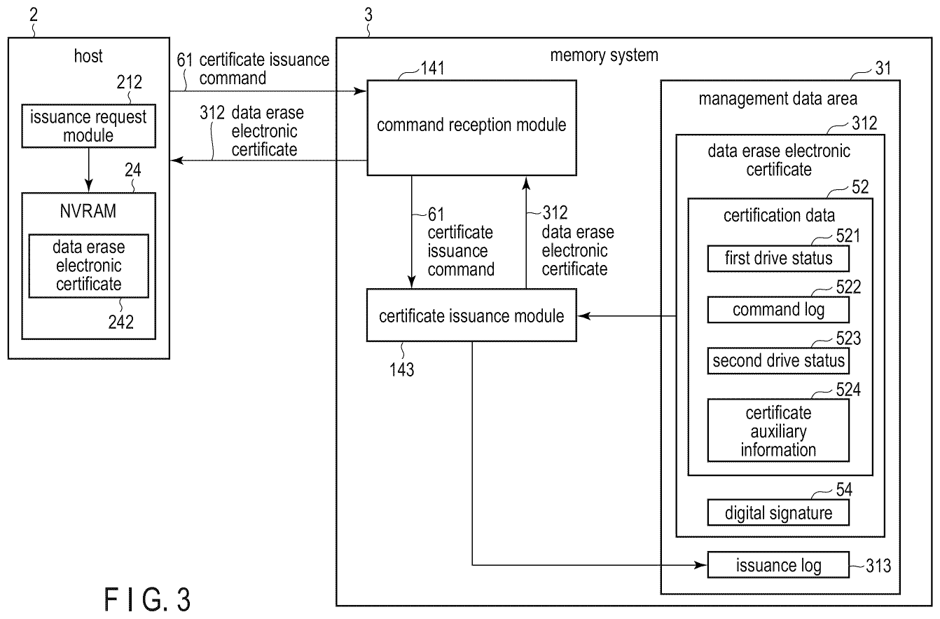

The CPU 14 functions as, for example, a command reception module 141, a data erase and certificate generation module 142, and a certificate issuance module 143. The CPU 14 functions as each of these modules, for example, by executing the FW. Specific operations of the command reception module 141, the data erase and certificate generation module 142, and the certificate issuance module 143 will be described with reference to FIGS. 2 and 3.

FIG. 2 is a diagram illustrating an example of a data erase and certificate generation operation performed by the memory system 3 and the host 2. In the data erase and certificate generation operation, in response to a request from the host 2, a data erase operation is performed on the user data area 32 and the data erase electronic certificate 312 is generated.

Specifically, first, the data erase and certificate generation request module 211 of the host 2 transmits a data erase and certificate generation command 51 to the memory system 3. The data erase and certificate generation command 51 is a command to perform a data erase operation on the user data area 32 and generate the data erase electronic certificate 312. The data erase and certificate generation command 51 may include an identifier indicating whether generation of the data erase electronic certificate 312 is necessary or not. Hereinafter, a case where generation of the data erase electronic certificate 312 is requested with the data erase and certificate generation command 51 (for example, a case where the data erase and certificate generation command 51 includes an identifier indicating that generation of the data erase electronic certificate 312 is necessary) will be explained.

The command reception module 141 of the memory system 3 receives the data erase and certificate generation command 51 transmitted from the host 2. The command reception module 141 transmits the received data erase and certificate generation command 51 to the data erase and certificate generation module 142.

The data erase and certificate generation module 142 includes, for example, a first status acquisition module 41, an erase processing module 42, a second status acquisition module 43, and a certificate generation module 44.

In response to the data erase and certificate generation command 51, the first status acquisition module 41 acquires a drive status of the memory system 3 before a data erase operation on the user data area 32 is performed. The drive status includes one or more parameters related to a degree of wear-out of the NAND flash memory 4. The one or more parameters related to the degree of wear-out include, for example, the number of P/E cycles, power-on periods, the number of times of reset (power cycle count), a total number of LBAs subjected to write operations (total LBA written), a total number of LBAs subjected to read operations (total LBA read), the number of reallocated sectors (reallocated sector count), the number of failed program operations (program fail count), the number of failed erase operations (erase fail count), the number of unexpected losses of power supply (unexpected power loss count), and the number of times of occurrence of uncorrectable error (uncorrectable error count). The one or more parameters related to the degree of wear-out are used, for example, for determining the longevity of the memory system 3.

The drive status acquired before the data erase operation on the user data area 32 is performed is referred to as a first drive status 521. The first drive status 521 may include information related to the number of P/E cycles for at least one storage area (hereinafter also referred to as a first storage area) among the storage areas of the specific unit that are allocated as the user data area 32. More specifically, the first drive status 521 includes, for example, the sum of the numbers of P/E cycles for the respective storage areas of the specific unit, the number of P/E cycles for each of the storage areas of the specific unit, or a statistical value of the numbers of P/E cycles for the respective storage areas of the specific unit. The statistical value of the numbers of P/E cycles is, for example, at least one of a maximum value, a minimum value, an average value, a deviation value, and a median value. The first status acquisition module 41 stores the acquired first drive status 521 in the management data area 31.

When the first drive status 521 has been acquired, the erase processing module 42 executes a data erase operation on the user data area 32. More specifically, the erase processing module 42 executes a data erase operation on each of the storage areas allocated as the user data area 32.

The data erase operation executed by the erase processing module 42 is, for example, an operation similar to an operation in accordance with a Format NVM command defined in the NVMe standard (i.e., format operation). Note that as the Secure Erase Settings (SES) parameter of the Format NVM command, a value indicative of either User Data Erase or

Cryptographic Erase is set. In a case where the value indicative of User Data Erase is set as the SES parameter, all user data stored in the user data area 32 is erased in the format operation. In a case where the value indicative of Cryptographic Erase is set as the SES parameter, an encryption key that was used for encryption of user data (encrypted user data) stored in the user data area 32 is deleted in the format operation.

Alternatively, the data erase operation executed by the erase processing module 42 may be an operation similar to an operation in accordance with a Sanitize command defined in the NVMe standard (sanitize operation). The sanitize operation is one of Block Erase, Crypto Erase, and Overwrite.

The erase processing module 42 generates a log related to the executed data erase operation (hereinafter referred to as a command log 522). The command log 522 includes information indicative of a mode of the executed data erase operation. For example, the information indicative of a mode of the executed data erase operation indicates User Data Erase or Cryptographic Erase of the format operation, or indicates Block erase, Crypto erase, or Overwrite of the sanitize operation. For example, when the data erase operation on the whole user data area 32 is successful, the command log 522 includes information indicating that the data erase operation is successful.

In contrast, for example, when the data erase operation on at least part of the user data area 32 is unsuccessful, the command log 522 includes information indicating that the data erase operation is unsuccessful. The erase processing module 42 stores the generated command log 522 in the management data area 31.

In addition, the erase processing module 42 may send a notification 55 indicating whether the data erase operation is successful or not to the command reception module 141. More specifically, when the data erase operation on all the storage areas allocated as the user data area 32 is successful, the erase processing module 42 sends a notification 55 indicating that the data erase operation is successful to the command reception module 141. When the data erase operation on at least part of the storage areas allocated as the user data area 32 is unsuccessful, the erase processing module 42 sends a notification 55 indicating that the data erase operation is unsuccessful to the command reception module 141.

When the data erase operation by the erase processing module 42 has been completed, the second status acquisition module 43 acquires a drive status of the memory system 3. The drive status acquired after the data erase operation on the user data area 32 is completed is referred to as a second drive status 523. The details of the second drive status 523 are similar to those of the first drive status 521 except that the second drive status is acquired after the data erase operation is completed. The second status acquisition module 43 stores the acquired second drive status 523 in the management data area 31.

The certificate generation module 44 generates the data erase electronic certificate 312 after the second drive status 523 is acquired. The certificate generation module 44 includes, for example, an auxiliary information generation module 441, a hash value calculation module 442, and a signature generation module 443.

The auxiliary information generation module 441 generates certificate auxiliary information 524.

The certificate auxiliary information 524 includes information for managing the data erase electronic certificate 312 to be generated. Specifically, the certificate auxiliary information 524 includes, for example, a serial number assigned to the data erase electronic certificate 312, and information indicative of an algorithm used to generate a digital signature 54. In a case where the algorithm used to generate the digital signature 54 is a digital signature algorithm (DSA), the certificate auxiliary information 524 further includes a domain parameter. The auxiliary information generation module 441 stores the generated certificate auxiliary information 524 in the management data area 31.

Next, the hash value calculation module 442 calculates a hash value 53 of certification data 52 stored in the management data area 31. The certification data 52 is data certifying that the data erase operation on the user data area 32 has been performed. More specifically, the certification data 52 is data that includes the first drive status 521, the command log 522, the second drive status 523, and the certificate auxiliary information 524. The hash value 53 is calculated by using a specific hash function. The hash value calculation module 442 sends the calculated hash value 53 to the signature generation module 443.

The signature generation module 443 generates the digital signature 54 for the certification data 52 by using the hash value 53 and the signature key 311 that is stored in the management data area 31. The digital signature 54 ensures the integrity of the certification data 52. As an algorithm for generating the digital signature 54, any digital signature generation algorithm such as a Rivest-Shamir-Adleman (RSA) algorithm or the DSA is used. For example, in a case where the RSA algorithm is used, the signature generation module 443 generates the digital signature 54 by encrypting the hash value 53 with the signature key 311. In addition, for example, in a case where the DSA is used, the signature generation module 443 generates the digital signature 54 by a modular exponentiation operation using the hash value 53, the domain parameter, and the signature key 311. The digital signature 54 based on the DSA includes, for example, a set including two numerical values (R, S). The signature generation module 443 stores the generated digital signature 54 in the management data area 31. As a result, the data erase electronic certificate 312 that includes the certification data 52 and the digital signature 54 is generated. The signature generation module 443 sends a notification 56 indicating that the generation of the data erase electronic certificate 312 has been completed to the command reception module 141.

The command reception module 141 transmits, to the host 2, a completion notification of data erase and certificate generation 57 as a response to the data erase and certificate generation command 51. The completion notification of data erase and certificate generation 57 includes, for example, a first identifier and a second identifier as statuses of processing results of the data erase and certificate generation command 51. The first identifier indicates whether the data erase operation is successful or not. The first identifier is set, for example, on the basis of the notification 55 sent by the erase processing module 42. The second identifier indicates whether the data erase electronic certificate 312 has been generated or not. The second identifier is set on the basis of the notification 56 sent by the signature generation module 443.

With the above-described data erase and certificate generation operation, in accordance with the data erase and certificate generation command 51 transmitted by the host 2, the memory system 3 can execute the data erase operation on the user data area 32 and generate the data erase electronic certificate 312. By using the data erase and certificate generation command 51, the host 2 can request the memory system 3 to execute the data erase operation on the user data area 32 and generate the data erase electronic certificate 312 and can acquire a response indicating the processing results. The data erase electronic certificate 312 includes the first drive status 521 and the second drive status 523. By using the first drive status 521 and the second drive status 523, the host 2 can confirm, for example, whether the data erase operation on the user data area 32 has been executed and the degree of wear-out of the NAND flash memory 4. Therefore, the data erase electronic certificate 312 can improve reliability and usefulness in certifying that the user data has been erased from the NAND flash memory 4.

FIG. 3 is a diagram illustrating an example of a certificate issuance operation performed by the memory system 3 and the host 2. In the certificate issuance operation, the latest data erase electronic certificate 312 of the memory system 3 is issued to the host 2 in response to a request from the host 2.

Specifically, first, the issuance request module 212 of the host 2 transmits a certificate issuance command 61 to the memory system 3. The certificate issuance command 61 is a command to the issuance of the data erase electronic certificate 312. Note that the host 2 that transmits the certificate issuance command 61 may be a host different from the host 2 that transmitted the data erase and certificate generation command 51 to the memory system 3 (that is, the host 2 that caused the memory system 3 to generate the data erase electronic certificate 312).

The command reception module 141 of the memory system 3 receives the certificate issuance command 61 transmitted from the host 2. The command reception module 141 sends the received certificate issuance command 61 to the certificate issuance module 143.

The certificate issuance module 143 reads the latest data erase electronic certificate 312 from the management data area 31. The certificate issuance module 143 reads the latest data erase electronic certificate 312 from, for example, a specific storage area in the management data area 31. In a case where the management data area 31 stores multiple data erase electronic certificates 312, the certificate issuance module 143 is capable of identifying the latest data erase electronic certificate 312, for example, on the basis of serial numbers that are assigned to the multiple data erase electronic certificates 312, respectively. The certificate issuance module 143 sends the read latest data erase electronic certificate 312 to the command reception module 141.

In addition, the certificate issuance module 143 updates the issuance log 313. For example, the certificate issuance module 143 adds, to the issuance log 313, information that includes the serial number assigned to the issued data erase electronic certificate 312, identification information of the host 2, and the date and time when the data erase electronic certificate 312 is transmitted to the host 2. The command reception module 141 transmits,

to the host 2, the latest data erase electronic certificate 312 received from the certificate issuance module 143. For example, the command reception module 141 transmits the data erase electronic certificate 312 to the host 2 as a response to the certificate issuance command 61.

The issuance request module 212 of the host 2 stores the data erase electronic certificate 312 received from the memory system 3 in the NVRAM 24, for example. In the example illustrated in FIG. 3, the data erase electronic certificate 242 stored in the NVRAM 24 is the data erase electronic certificate 312 received from the memory system 3 and stored in the NVRAM 24.

With the above-described issuance operation, the memory system 3 can issue the latest data erase electronic certificate 312 to the host 2 in response to the certificate issuance command 61 from the host 2. The host 2 can acquire the latest data erase electronic certificate 312 of the memory system 3 by using the certificate issuance command 61.

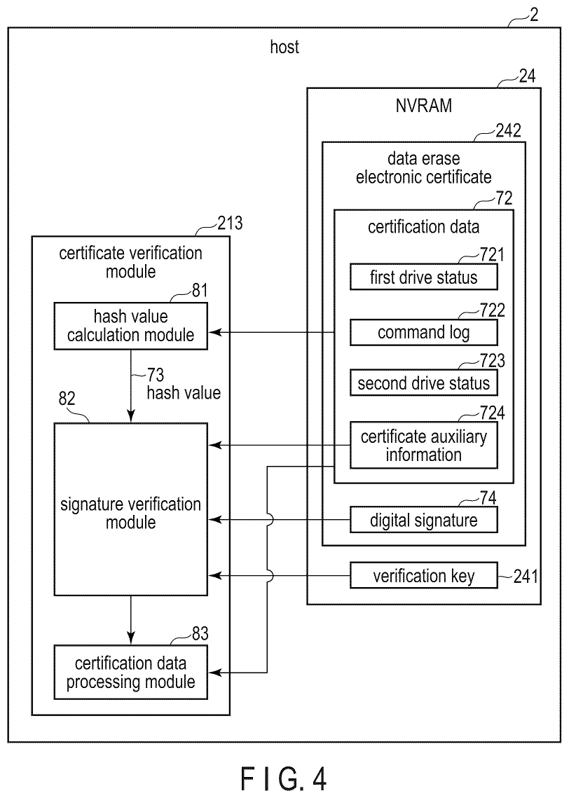

FIG. 4 is a diagram illustrating an example of a certificate verification operation performed in the host 2. The certificate verification operation is an operation of verifying the data erase electronic certificate 242 stored in the NVRAM 24. Here, a case where the data erase electronic certificate 242 is derived from the data erase electronic certificate 312 of the memory system 3 will be explained. In this case, the verification key 241 stored in the NVRAM 24 is a verification key generated for the memory system 3 (that is, a verification key paired with the signature key 311).

The data erase electronic certificate 242 includes certification data 72 and a digital signature 74. The certification data 72 is data certifying that a data erase operation has been performed on the user data area 32 in the memory system 3 that issued the data erase electronic certificate 242. More specifically, the certification data 72 is data that includes a first drive status 721, a command log 722, a second drive status 723, and certificate auxiliary information 724. The digital signature 74 is data for verifying the integrity of the certification data 72.

The certificate verification module 213 includes, for example, a hash value calculation module 81, a signature verification module 82, and a certification data processing module 83.

The hash value calculation module 81 calculates a hash value 73 of the certification data 72. The hash value 73 is calculated by using a specific hash function. The hash function used to calculate the hash value 73 is the same as the hash function used for the hash value calculation module 442 of the memory system 3 to calculate the hash value 53. The hash value calculation module 81 sends the calculated hash value 73 to the signature verification module 82.

The signature verification module 82 verifies the validity of the digital signature 74 by using the hash value 73, the certificate auxiliary information 724, the digital signature 74, and the verification key 241. The signature verification module 82 notifies the certification data processing module 83 whether the digital signature 74 is valid or not.

Specifically, for example, in a case where the signature generation algorithm indicated by the certificate auxiliary information 724 is the RSA algorithm, the signature verification module 82 determines whether a hash value that is obtained by decrypting the digital signature 74 with the verification key 241 matches the hash value 73. When the two hash values match, the signature verification module 82 determines that the digital signature 74 is valid. When the two hash values do not match, the signature verification module 82 determines that the digital signature 74 is invalid.

In addition, for example, in a case where the signature generation algorithm indicated by the certificate auxiliary information 724 is the DSA, the signature verification module 82 generates a numerical value Q by a modular exponentiation operation using the hash value 73, a numerical value S in the digital signature 74, and the verification key 241. Then, the signature verification module 82 determines whether the generated numerical value Q matches a numerical value R in the digital signature 74. When the numerical value Q and the numerical value R match, the signature verification module 82 determines that the digital signature 74 is valid. When the numerical value Q and the numerical value R do not match, the signature verification module 82 determines that the digital signature 74 is invalid.

The certification data processing module 83 performs a process depending on whether the digital signature 74 is valid.

When the digital signature 74 is invalid, the certification data processing module 83 determines that the integrity of the certification data 72 is not confirmed. Therefore, the certification data processing module 83 determines that the data erase electronic certificate 242 is a possibly forged data erase electronic certificate. The certification data processing module 83 may notify a user of the host 2 that, for example, the data erase electronic certificate 242 is a possibly forged data erase electronic certificate. Further, the certification data 72 whose integrity is not confirmed does not certify any data erase operation performed on the user data area 32 of the memory system 3. Thus, the certification data processing module 83 does not use the certification data 72, thereby, for example, neither notifying the user of the host 2 whether a data erase operation on the user data area 32 of the memory system 3 has been executed nor notifying the user of the degree of wear-out of the NAND flash memory 4 and the like.

When the digital signature 74 is valid, the certification data processing module 83 determines that the integrity of the certification data 72 has been confirmed. The certification data 72 whose integrity has been confirmed certifies the data erase operation performed on the user data area 32 of the memory system 3. Therefore, the certification data processing module 83 may use the certification data 72 to, for example, notify the user of the host 2 of whether the data erase operation on the user data area 32 has been executed or notify the user of the degree of wear-out of the NAND flash memory 4 and the like.

A method for determining whether the data erase operation on the user data area 32 has been executed by using the certification data 72 whose integrity has been confirmed will be described. The first drive status 721 includes information related to the number of P/E cycles for at least one storage area (first storage area) before the data erase operation is executed, among the plurality of storage areas of the specific unit that are allocated as the user data area 32. The second drive status 723 includes information related to the number of P/E cycles for the first storage area after the data erase operation is executed. By using the first drive status 721 and the second drive status 723, the certification data processing module 83 determines whether the number of P/E cycles after the data erase operation increases from the number of P/E cycles before the data erase operation by one cycle per storage area of the specific unit. When the number of P/E cycles after the data erase operation increases from the number of P/E cycles before the data erase operation by one cycle per one storage area of the specific unit, the certification data processing module 83 determines that the data erase operation on the user data area 32 has been executed. Since having confirmed that the data erase operation on the user data area 32 has been executed, the host 2 does not need to further request the memory system 3 to perform a data erase operation. As a result, an unnecessary data erase operation will not be performed, the longevity of the memory system 3 (more specifically, the NAND flash memory 4) can be thus extended. Note that when the number of P/E cycles after the data erase operation does not increase from the number of P/E cycles before the data erase operation, the certification data processing module 83 determines that a data erase operation on the user data area 32 was not executed.

Next, a method of determining the degree of wear-out of the NAND flash memory 4 by using the certification data 72 whose integrity has been confirmed will be described. For example, the certification data processing module 83 determines the degree of wear-out of the NAND flash memory 4 by comparing the number of P/E cycles indicated by the second drive status 723 with the maximum number of P/E cycles of the NAND flash memory 4. Note that the certification data processing module 83 may determine the degree of wear-out of the NAND flash memory 4, based on a parameter related to the degree of wear-out other than the number of P/E cycles included in the certification data 72. The host 2 can confirm the state (e.g., the longevity) of the memory system 3 to be reused, based on the degree of wear-out of the NAND flash memory 4.

With the above-described certificate verification operation, the host 2 can verify the data erase electronic certificate 242 that is derived from the data erase electronic certificate 312 of the memory system 3. Specifically, when the digital signature 74 is valid and the integrity of the certification data 72 has been confirmed, the host 2 can use the certification data 72 to confirm the content of the data erase operation performed in the memory system 3. On the other hand, when the digital signature 74 is invalid and the integrity of the certification data 72 is not confirmed, the host 2 can determine that the data erase electronic certificate 242 is a possibly forged data erase electronic certificate.

Note that the host 2 that performs the certificate verification operation may be a host different from the host 2 that received the data erase electronic certificate 312 from the memory system 3 by using the certificate issuance command 61. That is, the data erase electronic certificate 242 stored in the NVRAM 24 may be the data erase electronic certificate 312 acquired directly or indirectly from the memory system 3. The host 2 that has acquired the data erase electronic certificate 242 can verify the data erase operation performed in the memory system 3 by using the data erase electronic certificate 242, even after the memory system 3 is discarded.

To the certificate issuance operation and the certificate verification operation, a protocol of the security protocol and data model (SPDM) defined by the distributed management task force (DMTF) may be applied, for example. The SPDM is one of device management specifications. In the SPDM, a protocol for acquiring a certificate from a device and verifying the acquired certificate according to the PKI is defined.

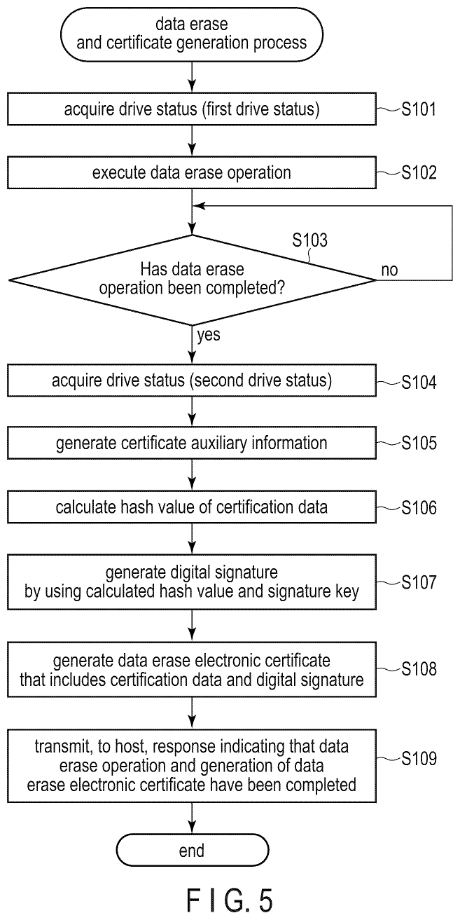

Next, processes executed in the memory system 3 and the host 2 will be described with reference to FIGS. 5 to 7.

FIG. 5 is a flowchart illustrating an example of the procedure of a data erase and certificate generation process executed by the CPU 14 of the memory system 3. The data erase and certificate generation process is a process of performing a data erase operation on the user data area 32 and generating the data erase electronic certificate 312. The CPU 14 executes the data erase and certificate generation process upon receiving a data erase and certificate generation command 51 from the host 2.

First, the CPU 14 acquires a drive status (first drive status 521) of the memory system 3 (step S101). The first drive status 521 includes information related to the number of P/E cycles for at least one storage area (first storage area) among the plurality of storage areas that are allocated as the user data area 32.

When the acquisition of the first drive status 521 has been completed, the CPU 14 executes a data erase operation on the user data area 32 (step S102). That is, the CPU 14 executes the data erase operation on each of the plurality of storage areas allocated as the user data area 32. The CPU 14 generates the command log 522 related to the executed data erase operation.

Then, the CPU 14 determines whether the data erase operation on the user data area 32 has been completed (step S103). When the data erase operation on the user data area 32 has not been completed (no in step S103), the process executed by the CPU 14 returns to step S103.

When the data erase operation on the user data area 32 has been completed (yes in step S103), the CPU 14 acquires a drive status (second drive status 523) of the memory system 3 (step S104). The second drive status 523 includes information related to the number of P/E cycles for the first storage area. Then, the CPU 14 generates the certificate auxiliary information 524 (step S105). The certificate auxiliary information 524 includes information for managing the data erase electronic certificate 312 to be generated.

Next, the CPU 14 calculates the hash value 53 of the certification data 52 that includes the first drive status 521, the command log 522, the second drive status 523, and the certificate auxiliary information 524 (step S106). The CPU 14 generates the digital signature 54 by using the calculated hash value 53 and the signature key 311 (step S107). The CPU 14 generates the data erase electronic certificate 312 that includes the certification data 52 and the digital signature 54 (step S108). Then, the CPU 14 transmits, to the host 2, a response indicating that the data erase operation and the generation of the data erase electronic certificate 312 have been completed (step S109), and ends the data erase and certificate generation process.

Through the above-described data erase and certificate generation process, the CPU 14 can perform the data erase operation on the user data area 32 and generate the data erase electronic certificate 312. The data erase electronic certificate 312 includes the first drive status 521 before the data erase operation is started and the second drive status 523 after the data erase operation is completed. By using the first drive status 521 and the second drive status 523, the data erase electronic certificate 312 can indicate, for example, that the data erase operation has been performed actually and the degree of wear-out of the NAND flash memory 4.

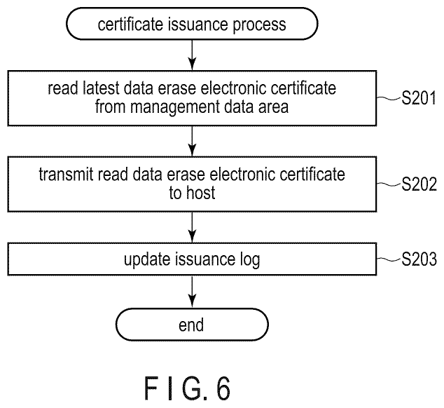

FIG. 6 is a flowchart illustrating an example of the procedure of a certificate issuance process executed by the CPU 14 of the memory system 3. The certificate issuance process is a process of issuing (transmitting) the data erase electronic certificate 312 stored in the memory system 3 to the host 2. The CPU 14 executes the certificate issuance process upon receiving a certificate issuance command 61 from the host 2.

First, the CPU 14 reads the latest data erase electronic certificate 312 from the management data area 31 (step S201). The CPU 14 transmits the read data erase electronic certificate 312 to the host 2 (step S202). Specifically, the CPU 14 transmits the data erase electronic certificate 312 to the host 2, for example, as a response to the certificate issuance command 61.

Then, the CPU 14 updates the issuance log 313 (step S203) and ends the certificate issuance process. For example, the CPU 14 adds, to the issuance log 313, information that includes a serial number assigned to the data erase electronic certificate 312, identification information of the host 2, and the date and time when the data erase electronic certificate 312 is transmitted to the host 2.

Through the above-described certificate issuance process, the CPU 14 can issue the latest data erase electronic certificate 312 to the host 2. The CPU 14 can provide the data erase electronic certificate 242 to any host 2 that is not limited to the host 2 that requested the memory system 3 to execute the data erase and certificate generation process.

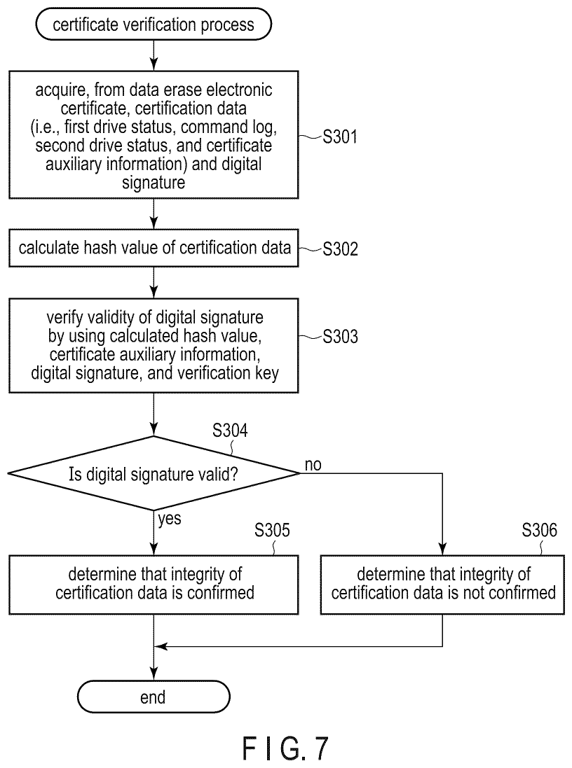

FIG. 7 is a flowchart illustrating an example of the procedure of a certificate verification process executed by the CPU 21 of the host 2. The certificate verification process is a process of verifying the integrity of the certification data 72 included in the data erase electronic certificate 242. The host 2 in which the certificate verification process is executed is a host that has received the data erase electronic certificate 242 directly or indirectly from the memory system 3.

First, the CPU 21 acquires the certification data 72 and the digital signature 74 from the data erase electronic certificate 242 (step S301). The certification data 72 includes the first drive status 721, the command log 722, the second drive status 723, and the certificate auxiliary information 724. The CPU 21 calculates the hash value 73 of the certification data 72 (step S302).

Next, the CPU 21 verifies the validity of the digital signature 74 by using the calculated hash value 73, the certificate auxiliary information 724, the digital signature 74, and the verification key 241 (step S303). The CPU 21 determines whether the digital signature 74 is valid on the basis of the results of the verification (step S304). When the digital signature 74 is valid (yes in step S304), the CPU 21 determines that the integrity of the certification data 72 has been confirmed (step S305) and ends the certificate verification process. When the digital signature 74 is invalid (no in step S304), the CPU 21 determines that the integrity of the certification data 72 is not confirmed (step S306) and ends the certificate verification process.

Through the above-described certificate verification process, the CPU 21 can verify the integrity of the certification data 72 by using the digital signature 74. The certification data 72 whose integrity has been confirmed certifies a data erase operation performed on the memory system 3 (more specifically, the user data area 32 of the NAND flash memory 4). Therefore, the CPU 21 can use the certification data 72 to confirm whether the data erase operation on the memory system 3 has been executed, the degree of wear-out of the NAND flash memory 4, and the like.

On the other hand, the certification data 72 whose integrity is not confirmed does not certify any data erase operation performed on the memory system 3. Therefore, the CPU 21 does not use the certification data 72, thereby neither confirming whether a data erase operation on the memory system 3 has been executed nor confirming the degree of wear-out of the NAND flash memory 4 and the like.

As described above, according to the present embodiment, it is possible to improve reliability and usefulness in certifying that data has been erased from the nonvolatile memory 4. The nonvolatile memory 4 (e.g., the NAND flash memory 4) includes a plurality of first storage areas each configured to store user data (user data area 32). The first status acquisition module 41 acquires first information (e.g., first drive status 521) related to the number of P/E cycles for at least one of the plurality of first storage areas. In response to the acquisition of the first information, the erase processing module 42 executes a data erase operation on each of the plurality of first storage areas. In response to the completion of the data erase operation, the second status acquisition module 43 acquires second information (e.g., second drive status 523) related to the number of program/erase cycles for the at least one of the plurality of first storage areas. The certificate generation module 44 generates the data erase electronic certificate 312 that includes the first information and the second information.

With the above-described configuration, the host 2 that has acquired the data erase electronic certificate 312 can confirm, for example, whether a data erase operation on the user data area 32 has been executed and the degree of wear-out of the NAND flash memory 4 by using the first information and the second information. Therefore, the data erase electronic certificate 312 can improve reliability and usefulness in certifying that user data has been erased from the NAND flash memory 4.

Each of the various functions described in the embodiment may be realized by a circuit (e.g., processing circuit). An exemplary processing circuit may be a programmed processor such as a central processing unit (CPU). The processor executes computer programs (instructions) stored in a memory thereby performs the described functions. The processor may be a microprocessor including an electric circuit. An exemplary processing circuit may be a digital signal processor (DSP), an application specific integrated circuit (ASIC), a microcontroller, a controller, or other electric circuit components. The components other than the CPU described according to the embodiment may be realized in a processing circuit.

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is:

1. A memory system comprising:
a nonvolatile memory that includes a plurality of first storage areas each configured to store user data; and
a controller configured to:
acquire first information related to the number of program/erase cycles for at least one of the plurality of first storage areas;
in response to acquisition of the first information, execute a data erase operation on each of the plurality of first storage areas;
in response to completion of the data erase operation, acquire second information related to the number of program/erase cycles for the at least one of the plurality of first storage areas; and
generate an erase certificate that includes the first information and the second information.

2. The memory system according to claim 1, wherein
the nonvolatile memory further includes a second storage area that stores a signature key, and
the controller is further configured to:
generate log data related to the executed data erase operation;
generate auxiliary information for managing the erase certificate;
calculate a hash value of certification data that includes the first information, the second information, the log data, and the auxiliary information;
generate a digital signature for the certification data by using the hash value and the signature key; and
generate the erase certificate that includes the certification data and the digital signature.

3. The memory system according to claim 1, wherein
the controller is configured to:
in response to receiving a first request from a first host, acquire the first information, the first request requesting the data erase operation on the plurality of first storage areas and generation of the erase certificate;
in response to the acquisition of the first information, execute the data erase operation on each of the plurality of first storage areas;
in response to the completion of the data erase operation, acquire the second information; and
generate the erase certificate that includes the first information and the second information.

4. The memory system according to claim 3, wherein
the controller is further configured to, in response to the generation of the erase certificate, transmit a response to the first request to the first host, the response indicating that the erase certificate has been generated.

5. The memory system according to claim 1, wherein
the controller is further configured to, in response to receiving a second request from a second host, transmit the erase certificate in a response to the second request to the second host, the second request requesting issuance of the erase certificate.

6. The memory system according to claim 1, wherein
the first information includes a sum of the numbers of program/erase cycles for the respective first storage areas before the data erase operation is executed, and
the second information includes a sum of the numbers of program/erase cycles for the respective first storage areas after the data erase operation is completed.

7. The memory system according to claim 1, wherein
the first information includes the number of program/erase cycles for each of the first storage areas before the data erase operation is executed, and
the second information includes the number of program/erase cycles for each of the first storage areas after the data erase operation is completed.

8. The memory system according to claim 1, wherein
the first information includes at least one of a maximum value and a minimum value of the numbers of program/erase cycles for the respective first storage areas before the data erase operation is executed, and
the second information includes at least one of a maximum value and a minimum value of the numbers of program/erase cycles for the respective first storage areas after the data erase operation is completed.

9. The memory system according to claim 1, wherein
at least one of the first information and the second information further includes one or more parameters related to a degree of wear-out of the nonvolatile memory.

10. The memory system according to claim 1, wherein
the nonvolatile memory includes a plurality of blocks, and
each of the first storage areas includes one or more blocks on which the data erase operation is executable in parallel, among the plurality of blocks.

11. A memory system comprising:
a nonvolatile memory that includes a plurality of first storage areas each configured to store user data; and
a controller configured to:
in response to a command from a host, execute a data erase operation on each of the plurality of first storage areas;
in response to completion of the data erase operation, acquire information related to the number of program/erase cycles for at least one of the plurality of first storage areas; and
generate an erase certificate that includes at least the information.

12. The memory system according to claim 11, wherein
the nonvolatile memory further includes a second storage area that stores a signature key, and
the controller is further configured to:
generate log data related to the executed data erase operation;
generate auxiliary information for managing the erase certificate;
calculate a hash value of certification data that includes the information, the log data, and the auxiliary information;
generate a digital signature for the certification data by using the hash value and the signature key; and
generate the erase certificate that includes the certification data and the digital signature.

13. The memory system according to claim 11, wherein
the controller is configured to:
in response to receiving a first request from a first host, execute the data erase operation, the first request requesting the data erase operation on the plurality of first storage areas and generation of the erase certificate; and
in response to the completion of the data erase operation, generate the erase certificate.

14. The memory system according to claim 13, wherein
the controller is further configured to, in response to the generation of the erase certificate, transmit a response to the first request to the first host, the response indicating that the erase certificate has been generated.

15. The memory system according to claim 11, wherein
the controller is further configured to, in response to receiving a second request from a second host, transmit the erase certificate in a response to the second request to the second host, the second request requesting issuance of the erase certificate.

16. The memory system according to claim 11, wherein
the information includes:
a sum of the numbers of program/erase cycles for the respective first storage areas before the data erase operation is executed; and
a sum of the numbers of program/erase cycles for the respective first storage areas after the data erase operation is completed.

17. The memory system according to claim 11, wherein
the information includes:
the number of program/erase cycles for each of the first storage areas before the data erase operation is executed; and
the number of program/erase cycles for each of the first storage areas after the data erase operation is completed.

18. The memory system according to claim 11, wherein
the information includes:
at least one of a maximum value and a minimum value of the numbers of program/erase cycles for the respective first storage areas before the data erase operation is executed, and
at least one of a maximum value and a minimum value of the numbers of program/erase cycles for the respective first storage areas after the data erase operation is completed.

19. The memory system according to claim 11, wherein
the information further includes one or more parameters related to a degree of wear-out of the nonvolatile memory.

20. The memory system according to claim 11, wherein
the nonvolatile memory includes a plurality of blocks, and
each of the first storage areas includes one or more blocks on which the data erase operation is executable in parallel, among the plurality of blocks.
